(19) United States
(12) Patent Application Publication
(10) Pub. No.: US 2017/0031263 A1
(43) Pub. Date: Feb. 2, 2017

(54) IMAGE FORMING APPARATUS AND METHOD OF CONTROLLING EXPOSURE UNIT USED THEREFOR

(71) Applicant: SAMSUNG ELECTRONICS CO., LTD., Suwon-si (KR)

(72) Inventors: Sang-bum WOO, Yongin-si (KR); Sung-dae KIM, Suwon-si (KR); Tae-hee KIM, Yongin-si (KR)

(73) Assignee: SAMSUNG ELECTRONICS CO., LTD., Suwon-si (KR)

(21) Appl. No.: 15/145,366

(22) Filed: May 3, 2016

(30) Foreign Application Priority Data
Jul. 27, 2015 (KR) 10-2015-0106100

(51) Int. Cl. G03G 15/043

(52) U.S. Cl. CPC G03G 15/043

(57) ABSTRACT

An image forming apparatus includes a detection unit configured to detect a linear velocity change of a photosensitive drum, which occurs when the photosensitive drum rotates, and an exposure controller configured to control an exposure timing of the exposure unit based on the linear velocity change of the photosensitive drum, which is detected by the detection unit.

### CROSS-REFERENCE TO RELATED APPLICATIONS

This application claims the benefit of Korean Patent Application No. 10-2015-0106100, filed on Jul. 27, 2015, in the Korean Intellectual Property Office, the disclosure of which is incorporated herein in its entirety by reference.

### BACKGROUND

1. Field

The present disclosure relates to an image forming apparatus and a method for controlling an exposure unit used therefor.

2. Description of the Related Art

In general, image forming apparatuses using electrophotography, such as laser printers, copy machines, multifunctional apparatuses, and facsimiles, include an optical scanner. The image forming apparatuses perform an operation of printing a desired image by forming an electrostatic latent image on a surface of a photosensitive drum using light beams outputted from the optical scanner and then transferring the electrostatic latent image onto paper.

An electrophotographic image forming apparatus such as a color laser printer includes four photosensitive drums prepared to respectively correspond to four colors of yellow, cyan, magenta, and black, an exposure unit for forming an electrostatic latent image of a desired image by scanning light onto each photosensitive drum, a developing device for developing the electrostatic latent image with a developer for each of the four colors, and an image forming medium (e.g., a transfer belt) for forming a color image completed by sequentially receiving and superimposing the images developed on the photosensitive drums and then transferring the formed color image onto paper.

Therefore, to print one desired color image, a final color image is generated by developing images of respective colors on the four photosensitive drums and superimposing the developed images on a same image location of the image forming medium and is printed on paper.

However, to correctly generate a desired color image by superimposing the images of the four colors on the same image location of the image forming medium, a start point and an end point where an image is transferred from each photosensitive drum to the image forming medium are needed to be all the same for the four colors. Because even though images are clearly developed on the four photosensitive drums, if the developed images are transferred to the image forming medium with a different location little by little, an incorrect color image is finally obtained.

Therefore, to correctly realize a color image, it is important to correctly match an exposure start time point of each photosensitive drum by the exposure unit by taking into account a traveling speed of the image forming medium, and setting a plurality of colors to be correctly superimposed to form one image is called color registration.

However, a photosensitive drum has a periodic linear velocity change. This is a phenomenon naturally occurring in all practical rotary systems except for an ideally perfect rotary system, and there are a plurality of causes such as a photosensitive drum shape error (eccentricity, run-out, or the like), a drum alignment/mounting property, a gear shape error, a gear transfer error, gear train structural incompleteness, a coupling angular velocity transfer error, and the like. The linear velocity change of the photosensitive drum, which occurs due to the causes, becomes a direct cause of a color mismatch.

### SUMMARY

Provided is an image forming apparatus capable of reducing an influence according to a linear velocity change of a photosensitive drum by controlling an exposure timing of an exposure unit and a method of controlling the exposure unit.

Provided is an image forming apparatus for compensating for a skew of a toner image by individually controlling light source modules of an exposure unit.

Additional aspects will be set forth in part in the description which follows and, in part, will be apparent from the description, or may be learned by practice of the presented exemplary embodiments.

According to an aspect of an exemplary embodiment, an image forming apparatus includes: at least one rotatable photosensitive drum; at least one exposure unit configured to form an electrostatic latent image on a surface of the photosensitive drum and including a plurality of light sources arranged along a main scanning direction; a developing unit configured to form a toner image by developing the electrostatic latent image formed on the surface of the photosensitive drum; a transfer medium to which the toner image formed on the surface of the photosensitive drum is transferred; a detection unit configured to detect a linear velocity change of the photosensitive drum, which occurs when the photosensitive drum rotates; and an exposure controller configured to control an exposure timing of the exposure unit based on the linear velocity change of the photosensitive drum, which is detected by the detection unit.

The exposure controller may be further configured to control an interval of the exposure timing of the exposure unit to be shorter than a reference interval if a linear velocity of the photosensitive drum is faster than a reference velocity and to control the interval of the exposure timing of the exposure unit to be longer than the reference interval if the linear velocity of the photosensitive drum is slower than the reference velocity.

The exposure controller may be further configured to control the exposure timing of the exposure unit by taking into account a phase of the linear velocity change of the photosensitive drum.

The photosensitive drum may include a plurality of photosensitive drums taking in charge of different colors, and the exposure unit may include a plurality of exposure units corresponding to the plurality of photosensitive drums.

The detection unit may be further configured to detect a linear velocity change of each of the plurality of photosensitive drums, and the exposure controller may be further configured to control an exposure timing of each of the plurality of exposure units based on the linear velocity change of each of the plurality of photosensitive drums.

The exposure controller may be further configured to control the exposure timing of the exposure unit such that offsets according to the linear velocity changes in the plurality of photosensitive drums are removed or match each other.

A plurality of detection patterns arranged along a sub-scanning direction may be formed on the transfer medium, and the detection unit may be further configured to detect the linear velocity change of the photosensitive drum from a gap change in the plurality of detection patterns in the sub-scanning direction.

The plurality of detection patterns may be parallel to or inclined from the main scanning direction.

The plurality of detection patterns may include first and second detection patterns spaced apart from each other along the main scanning direction, and the detection unit may include first and second sensors configured to detect the first and second detection patterns.

The first detection patterns may be arranged alternately with the second detection patterns in the sub-scanning direction.

The exposure unit may include a plurality of light source modules including the light sources, and the exposure controller may be further configured to individually control exposure timings of the plurality of light source modules.

The image forming apparatus may further include at least one driving motor configured to provide a rotation driving force to the plurality of photosensitive drums, wherein the number of driving motors is less than the number of photosensitive drums.

According to an aspect of another exemplary embodiment, an image forming apparatus includes: at least one rotatable photosensitive drum; at least one exposure unit configured to form an electrostatic latent image on a surface of the photosensitive drum and including a plurality of light source modules having a plurality of light sources and arranged along a main scanning direction; at least one developing unit configured to form a toner image by developing the electrostatic latent image formed on the surface of the photosensitive drum; a transfer medium to which the toner image formed on the surface of the photosensitive drum is transferred; detection patterns arranged on the transfer medium so as to be spaced apart from each other in a sub-scanning direction and the main scanning direction; a detection unit configured to detect a skew of the toner image transferred to the transfer medium by detecting a shift of the detection patterns in the sub-scanning direction; and an exposure controller configured to individually control exposure timings of the plurality of light source modules based on the skew detected by the detection unit.

According to an aspect of another exemplary embodiment, a method of controlling an exposure unit includes: detecting a linear velocity change of at least one photosensitive drum when the photosensitive drum rotates; and controlling an exposure timing of the exposure unit based on the detected linear velocity change of the photosensitive drum.

When the linear velocity of the photosensitive drum is faster than a reference velocity, an interval of the exposure timing of the exposure unit may be controlled to be shorter than a reference interval, and when the linear velocity of the photosensitive drum is slower than the reference velocity, the interval of the exposure timing of the exposure unit may be controlled to be longer than the reference interval.

The exposure timing of the exposure unit may be controlled by taking into account a phase of the linear velocity change of the photosensitive drum.

The detecting may include detecting a linear velocity change of each of a plurality of photosensitive drums, and the controlling may include controlling the exposure timing of the exposure unit such that offsets according to the linear velocity changes in the plurality of photosensitive drums are removed or match each other.

A skew amount of a toner image may be detected by using first and second detection patterns spaced apart from each other along a main scanning direction and first and second sensors configured to detect a change in the first and second detection patterns.

Exposure timings of a plurality of light source modules of the exposure unit may be individually controlled based on the skew amount of the toner image.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a configuration diagram of an image forming apparatus according to an exemplary embodiment;

FIG. 2A illustrates a linear velocity change of a photosensitive drum, and FIG. 2B(a) and FIG. 2B(b) illustrates a phenomenon according to the linear velocity change of the photosensitive drum;

FIG. 3A illustrates a block diagram of an image forming apparatus according to an exemplary embodiment, and FIG. 3B illustrates a block diagram of an image forming apparatus according to another exemplary embodiment;

FIGS. 4 (4a, 4b, 4c and 4d) illustrates an operation of compensating for color registration by controlling an exposure timing by an exposure controller;

FIGS. 5A and 5B illustrate arrangements of driving motors in an image forming apparatus, according to exemplary embodiments;

FIG. 6 illustrates an exposure unit according to an exemplary embodiment;

FIG. 7A illustrates a gap change in detection patterns according to a linear velocity change of a photosensitive drum when an interval of an exposure timing is constant, according to a comparative example, and FIG. 7B illustrates a gap change in detection patterns according to a linear velocity change of a photosensitive drum when an interval of an exposure timing is adjusted, according to an exemplary embodiment;

FIG. 8A illustrates an exposure control operation according to another exemplary embodiment, and FIG. 8B illustrates a result of the exposure control operation;

FIG. 9 illustrates a result of compensating for a color mismatch under exposure control, according to another exemplary embodiment;

FIGS. 10A and 10B illustrate detection patterns according to first and second exemplary embodiments;

FIGS. 11A and 11B illustrate detection patterns according to third and fourth exemplary embodiments;

FIG. 12 illustrates detection patterns according to a fifth exemplary embodiment and a detection unit for detecting the detection patterns;

FIGS. 13A and 13B illustrate an operation of detecting detection patterns by first and second sensors, and

FIGS. 14A and 14B illustrate an operation of detecting a skew of an image forming apparatus based on the detection result of the first and second sensors;

FIG. 15 illustrates an exposure unit according to an exemplary embodiment;

FIG. 16 illustrates a skew of Y-colored images with respect to K-colored images before an exposure controller controls an exposure timing;

FIG. 17A illustrates a timing diagram of applying exposure signals by the exposure controller, according to an exemplary embodiment, and FIG. 17B illustrates a skew compensation of the Y-colored images with respect to the K-colored images after the exposure controller controls an exposure timing, according to an exemplary embodiment; and

FIG. 18 illustrates detection of a linear velocity change of the photosensitive drum, according to another exemplary embodiment.

### DETAILED DESCRIPTION

Hereinafter, configurations and operations of the disclosed exemplary embodiments are described in detail with reference to the accompanying drawings.

The terms used in the specification will be schematically described, and then, the disclosed exemplary embodiments will be described in detail.

The terms used in this specification are those general terms currently widely used in the art, but the terms may vary according to the intention of those of ordinary skill in the art, precedents, or new technology in the art. Also, specified terms may be selected by the applicant, and in this case, the detailed meaning thereof will be described in the detailed description. Thus, the terms used in the specification should be understood not as simple names but based on the meaning of the terms and the overall description.

Throughout the specification, it will also be understood that when a component “includes” an element, unless there is another opposite description thereto, it should be understood that the component does not exclude another element but may further include another element.

The terms, such as ‘first’ and ‘second’, are not used as the limited meaning but used to classify a certain element from another element.

Reference will now be made in detail to exemplary embodiments, examples of which are illustrated in the accompanying drawings. In the drawings, parts irrelevant to the description are omitted to clearly describe the exemplary embodiments, and like reference numerals refer to like elements throughout. In this regard, the present exemplary embodiments may have different forms and should not be construed as being limited to the descriptions set forth herein.

Accordingly, the exemplary embodiments are merely described below, by referring to the figures, to explain aspects.

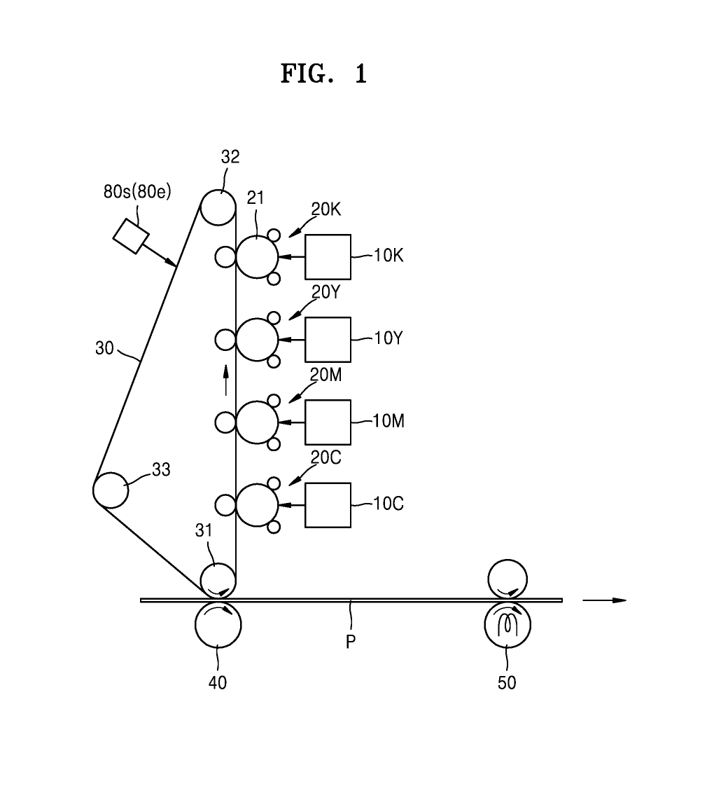

FIG. 1 illustrates a configuration diagram of an image forming apparatus according to an exemplary embodiment.

Referring to FIG. 1, the image forming apparatus may include exposure units (electrostatic latent image forming means) 10C, 10M, 10Y, and 10K, four developing units 20C, 20M, 20Y, and 20K in which toners of yellow (Y), magenta (M), cyan (C), and black (K) colors are respectively accommodated, a transfer belt (transfer medium) 30, a transfer roller 40, and a fixing roller 50.

The transfer belt 30 circulates by being supported by support rollers 31, 32, and 33. A drum-type transfer drum (not shown) may be used as the transfer medium 30. At least some support rollers 32 and 33 of the support rollers 31, 32, and 33 may be driving rollers.

The exposure unit 100 forms an electrostatic latent image by scanning light corresponding to C-colored image information on a photosensitive body (photosensitive drum) 21 of the developing unit 20C electrified with a uniform potential. The C-colored toner accommodated in the developing unit 20C is attached to the electrostatic latent image, thereby forming a C-colored toner image. The C-colored toner image is transferred to the transfer belt 30 by a transfer bias applied to the transfer roller 40.

The exposure unit 10M forms an electrostatic latent image by scanning light corresponding to M-colored image information on a photosensitive drum 21 of the developing unit 20M electrified with a uniform potential. The M-colored toner accommodated in the developing unit 20M is attached to the electrostatic latent image, thereby forming an M-colored toner image. The M-colored toner image is transferred to the transfer belt 30. In this case, an operating start time point of the exposure unit 10M is controlled so that the M-colored toner image is accurately superimposed with the C-colored toner image and transferred when a front end of the C-colored toner image arrives at a location where the photosensitive drum 21 faces the transfer belt 30.

The Y- and K-colored toner images are transferred to the transfer belt 30 in the same manner as described above, thereby forming, on the transfer belt 30, a color toner image in which C-, M-, Y-, and K-colored toner images are superimposed. The color toner image is transferred to a recording medium P passing between the transfer roller 40 and the support roller 31. When the recording medium P passes through the fixing roller 50, the color toner image is fixed to the recording medium P by heat and pressure, and accordingly, color printing is completed.

The recording medium P is fed by being adsorbed to the transfer belt 30 by an electrostatic force, and the toner images are directly transferred to the recording medium P by the transfer bias applied to the transfer roller 40.

According to an exemplary embodiment, it has been described with reference to FIG. 1 that a printing scheme of the image forming apparatus is a single path scheme. However, the printing scheme of the image forming apparatus is not limited thereto, and although not shown, the printing scheme of the image forming apparatus may be a multi-path scheme.

To correctly generate a desired color image on the transfer belt 30 which is an example of an image forming medium, the C-, M-, Y-, and K-colored toner images are supposed to be correctly superimposed with each other. To superimpose the images of the four colors on the same image location of the image forming medium, a start point and an end point where an image is transferred from each photosensitive drum 21 to the transfer belt 30 are needed to be all the same for the four colors. Even though images are clearly developed on the four photosensitive drums 21, if the developed images are transferred to the transfer belt 30 with a different location little by little, a finally obtained color image cannot have a correct color and image.

Therefore, to correctly realize a color image, it is significant to correctly match an exposure start time point of each photosensitive drum 21 by the exposure units 100, 10M, 10Y, and 10K by taking into account a traveling speed of the transfer belt 30. Matching exposure start time points so as to correctly superimpose a plurality of colors with which one image is to be formed is called color registration.

However, the photosensitive drum 21 may have a periodic linear velocity change. This is a phenomenon naturally occurring in all practical rotary systems except for an ideally perfect rotary system, and there are a plurality of causes such as a photosensitive drum shape error (eccentricity, run-out, or the like), a drum alignment/mounting property, a gear shape error, a gear transfer error, gear train structural incompleteness, a coupling angular velocity transfer error, and the like. The change in the linear velocity of the photosensitive drum 21, which occurs due to the causes, becomes a direct cause of a color mismatch. Herein, the linear velocity of the photosensitive drum 21 indicates a velocity of a surface of the photosensitive drum 21, which is measured at a certain location.

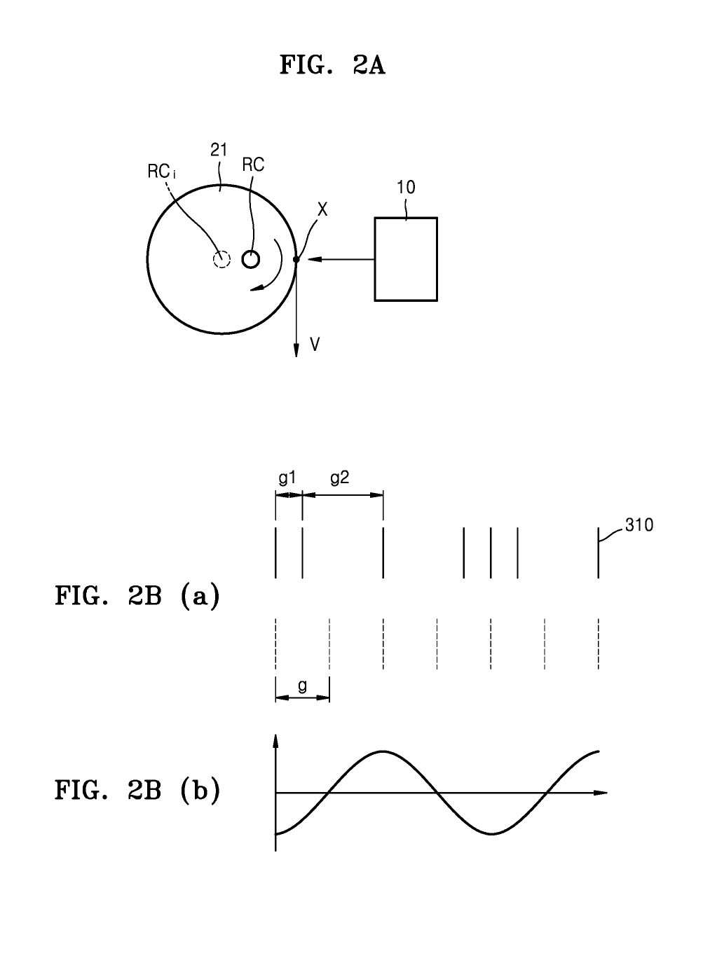

FIG. 2A illustrates a linear velocity change of the photosensitive drum 21, and FIG. 2B illustrates a phenomenon according to the linear velocity change of the photosensitive drum 21.

Referring to FIG. 2A, as an example of the periodic linear velocity change of the photosensitive drum 21, a practical rotation center RC of the photosensitive drum 21 may be formed at a location deviated from an ideal rotation center RCᵢ.

When the photosensitive drum 21 rotates based on the deviated rotation center RC, even though the photosensitive drum 21 rotates at a constant speed, a linear velocity V of the photosensitive drum 21, which is measured at a certain location X, periodically varies. For example, a phenomenon that the linear velocity V of the photosensitive drum 21 is fast and slow appears periodically. A linear velocity change ΔV of the photosensitive drum 21 may approximately have a sine curve shape.

The linear velocity V of the photosensitive drum 21 may be represented by Equation 1 as below.

V=Vo+A_color˜sin(ψt+Ph_color) (1)

In Equation 1, Vo denotes a reference velocity of the photosensitive drum 21, A_color denotes a change magnitude, ψ denotes an angular velocity (2πfo), fo denotes revolutions per second of the photosensitive drum 21, and Ph_color denotes a phase.

That is, the photosensitive drum 21 may have the linear velocity V changing with a certain period with respect to the reference velocity Vo.

When an exposure unit 10 performs light exposure on the surface of the photosensitive drum 21 having the periodic linear velocity change at a constant time interval, a gap between patterns of an electrostatic latent image formed on the surface of the photosensitive drum 21 may not be constant. A change in a gap between detection patterns 310 transferred to the transfer belt 30 may occur according to a change in the gap between patterns of the electrostatic latent image formed on the surface of the photosensitive drum 21.

For example, as shown in FIG. 2B(a), in a duration in which the linear velocity of the photosensitive drum 21 is slow, a gap g1 between the detection patterns 310 is narrower than a reference gap g, and in a duration in which the linear velocity of the photosensitive drum 21 is fast, a gap g2 between the detection patterns 310 is wider than the reference gap g. The reference gap g may be a gap between the detection patterns 310, which is measured when the photosensitive drum 21 rotates at the reference velocity Vo and an exposure start time point interval is a constant reference interval.

As described above, according to the linear velocity change ΔV of the photosensitive drum 21, a gap between the detection patterns 310 formed on the transfer belt 30 by the photosensitive drum 21 also periodically varies. Accordingly, a gap change Δg between the detection patterns 310 with respect to the reference gap g has a sine curve shape as shown in FIG. 2B(b).

When the photosensitive drum 21 is plural in number, a linear velocity change for each photosensitive drum 21 may vary. Accordingly, a gap change of the detection patterns 310 transferred to the transfer belt 30, which occurs according to the linear velocity change for each photosensitive drum 21, may also vary. As a result, when a toner image formed on each photosensitive drum 21 is transferred to the transfer belt 30, such a color registration error that toner image patterns of different colors are not correctly superimposed may occur.

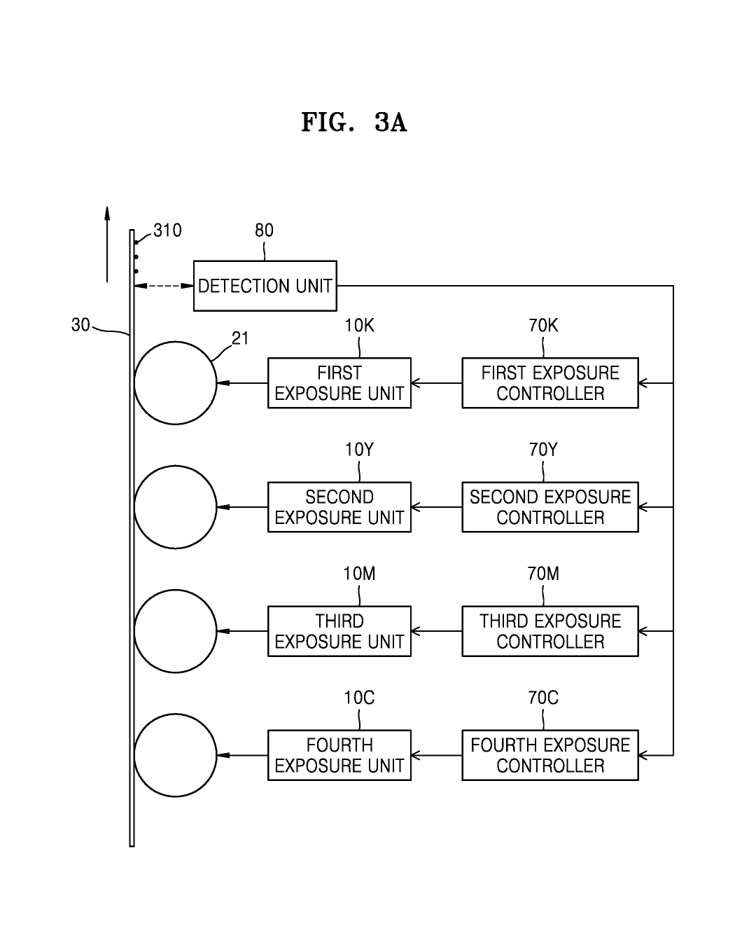

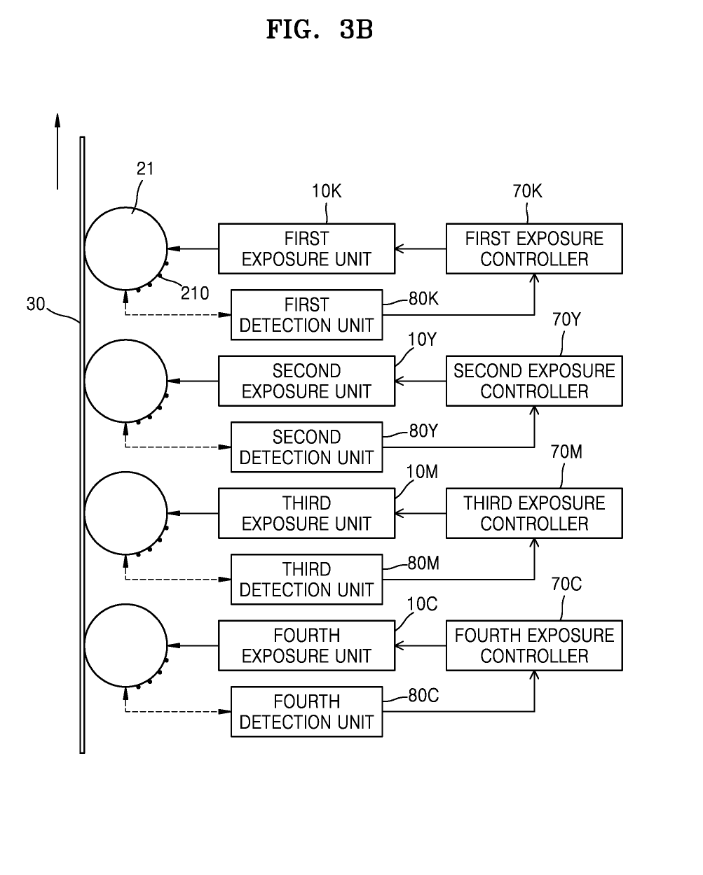

By taking into account the color registration error, the image forming apparatus according to an exemplary embodiment may include a detection unit 80 (see FIG. 3A) configured to detect a linear velocity change of the photosensitive drum 21 and an exposure controller 70 (see FIG. 3A) configured to control an exposure timing of the exposure unit 10 based on information detected by the detection unit 80.

FIG. 3A illustrates a block diagram of an image forming apparatus according to an exemplary embodiment, and FIG. 3B illustrates a block diagram of an image forming apparatus according to another exemplary embodiment.

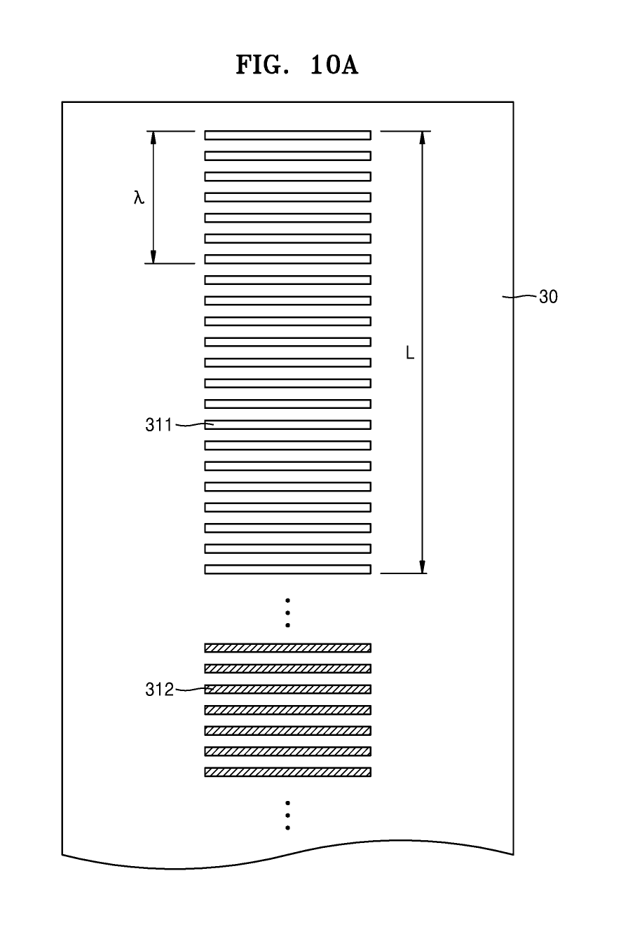

The detection unit 80 detects a linear velocity change of the photosensitive drum 21. For example, as shown in FIG. 3A, the detection unit 80 may detect a linear velocity change of the photosensitive drum 21 based on the detection patterns 310 formed on the transfer belt 30. As another example, as shown in FIG. 3B, each of individual detection units 80K, 80Y, 80M, and 80C may detect a linear velocity change of the photosensitive drum 21 based on detection patterns 210 formed on the photosensitive drum 21 or a gear connected to the photosensitive drum 21. A detailed configuration of the detection unit 80 will be described below with respect to FIGS. 10A through 18.

Exposure controllers 70K, 70Y, 70M, and 70C may control exposure timings of the exposure units 10K, 10Y, 10M, and 10C based on information detected by the detection unit 80, e.g., linear velocity changes of the photosensitive drums 21.

The exposure controllers 70K, 70Y, 70M, and 70C may control the plurality of exposure units 10K, 10Y, 10M, and 10C, respectively. The exposure controllers 70K, 70Y, 70M, and 70C may apply a certain control command to the plurality of exposure units 10K, 10Y, 10M, and 10C based on information detected by the detection unit 80, e.g., sine function-shaped linear velocity changes of the photosensitive drums 21. Although FIGS. 3A and 3B illustrate the plurality of exposure controllers 70K, 70Y, 70M, and 70C, the present exemplary embodiments are not limited thereto, and if the plurality of exposure units 10K, 10Y, 10M, and 10C are individually controlled, the plurality of exposure controllers 70K, 70Y, 70M, and 70C may be replaced with a single exposure controller.

The exposure controller 70K for the K-colored photosensitive drum 21 from among the plurality of exposure controllers 70K, 70Y, 70M, and 70C may control an exposure timing of the exposure unit 10K by reflecting a linear velocity change of the K-colored photosensitive drum 21.

The exposure controller 70Y for the Y-colored photosensitive drum 21 from among the plurality of exposure controllers 70K, 70Y, 70M, and 70C may control an exposure timing of the exposure unit 10Y by reflecting a linear velocity change of the Y-colored photosensitive drum 21.

The exposure controller 70M for the M-colored photosensitive drum 21 from among the plurality of exposure controllers 70K, 70Y, 70M, and 70C may control an exposure timing of the exposure unit 10M by reflecting a linear velocity change of the M-colored photosensitive drum 21.

The exposure controller 70C for the C-colored photosensitive drum 21 from among the plurality of exposure controllers 70K, 70Y, 70M, and 70C may control an exposure timing of the exposure unit 100 by reflecting a linear velocity change of the C-colored photosensitive drum 21.

These control operations for the individual exposure units 10K, 10Y, 10M, and 10C may be performed in a unit of one period of rotation of the photosensitive drum 21.

FIG. 4 illustrates an operation of compensating for color registration by controlling an exposure timing by the exposure controller 70. FIG. 4(a) illustrates a gap change of the detection patterns 310 formed on the transfer belt 30 when an interval of an exposure timing of the exposure unit 10 is constant and a linear velocity change of the photosensitive drum 21 occurs, and FIG. 4(b) illustrates a gap change of the detection patterns 310 formed on the transfer belt 30 when the photosensitive drum 21 rotates at a reference velocity and an interval of the exposure timing of the exposure unit 10 varies. FIG. 4(c) illustrates a gap change of the detection patterns 310 formed on the transfer belt 30 when the photosensitive drum 21 rotates at the reference velocity and an interval of the exposure timing of the exposure unit 10 is constant as the reference gap g. FIG. 4(d) illustrates an exposure timing applied to the exposure unit 10 by the exposure controller 70.

Referring to FIGS. 4(a) and (c), when a linear velocity of the photosensitive drum 21 is slower than the reference velocity, the gap g1 of the detection patterns 310 formed on the transfer belt 30 is narrower than the reference gap g. When the linear velocity of the photosensitive drum 21 is faster than the reference velocity, the gap g2 of the detection patterns 310 formed on the transfer belt 30 is wider than the reference gap g.

The exposure controller 70 according to an exemplary embodiment controls an exposure timing of the exposure unit 10 by taking into account such a linear velocity change of the photosensitive drum 21.

Referring to FIGS. 4(b) and (c), the exposure controller 70 controls the exposure unit 10 such that a gap change of the detection patterns 310, which is opposite to the gap change of the detection patterns 310 according to the linear velocity change of the photosensitive drum 21, occurs in case that the linear velocity change of the photosensitive drum 21 is constant. For example, at a time point where a gap of the detection patterns 310 according to the linear velocity change of the photosensitive drum 21 is g1 that is narrower than the reference gap g, the exposure controller 70 controls the exposure unit 10 such that the gap of the detection patterns 310 becomes g11 that is wider than the reference gap g in case that the linear velocity change of the photosensitive drum 21 is constant. Also, at a time point where a gap of the detection patterns 310 according to the linear velocity change of the photosensitive drum 21 is g2 that is wider than the reference gap g, the exposure controller 70 controls the exposure unit 10 such that the gap of the detection patterns 310 becomes g21 that is narrower than the reference gap g in case that the linear velocity change of the photosensitive drum 21 is constant.

Referring to FIG. 4(d), if the linear velocity of the photosensitive drum 21 is slower than the reference velocity, the exposure controller 70 controls an interval t1 of the exposure timing of the exposure unit 10 to be longer than a reference interval t. Whereas, if the linear velocity of the photosensitive drum 21 is faster than the reference velocity, the exposure controller 70 controls an interval t2 of the exposure timing of the exposure unit 10 to be shorter than the reference interval t.

For example, if a gap change of the detection patterns 310 according to a linear velocity change of the photosensitive drum 21 is represented by A·sin(ψt+φ), an exposure timing of the exposure unit 10 may be controlled such that a gap change of the detection patterns 310 on the transfer belt 30 according to the control on the exposure unit 10 becomes −A·sin(ψt+φ) when a linear velocity of the photosensitive drum 21 is constant. Herein, A denotes a certain amplitude, and φ denotes a certain phase.

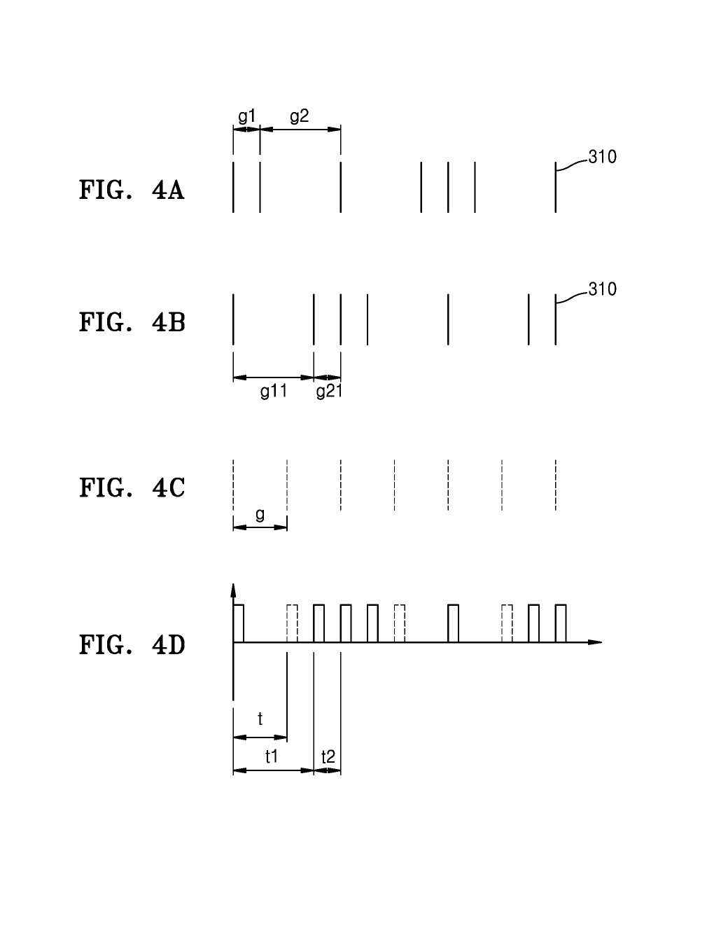

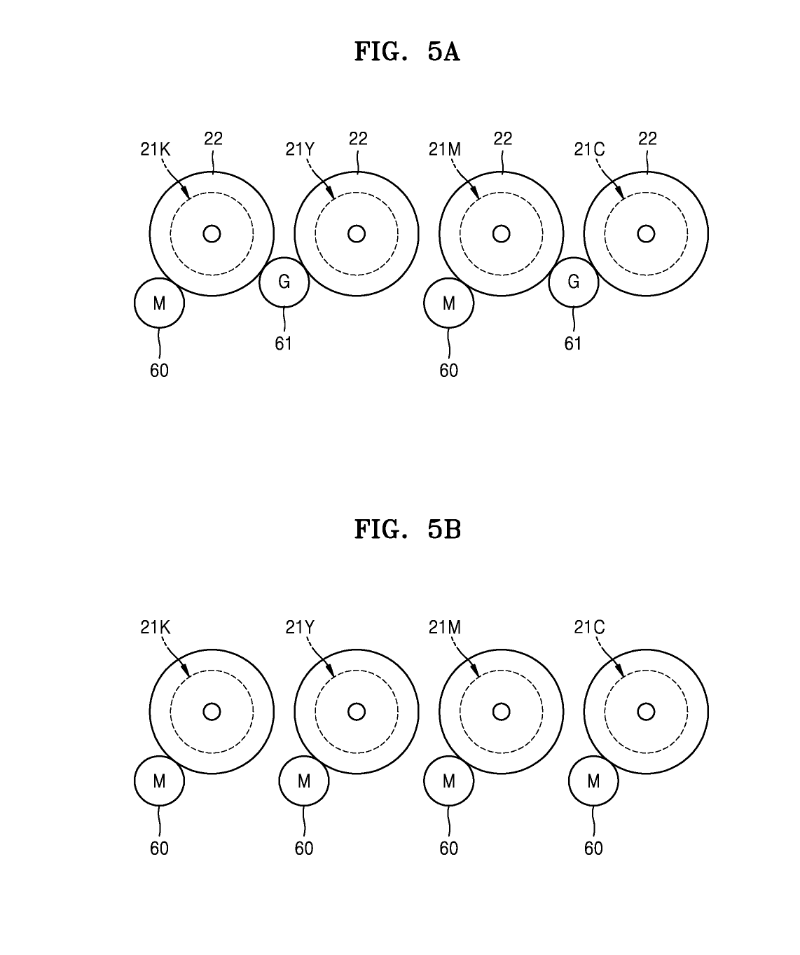

As described above, only with an operation of controlling an exposure timing of the exposure unit 10, a color mismatch according to a linear velocity change of the photosensitive drum 21 may be prevented or reduced. Since the color mismatch is prevented or reduced by controlling a signal applied to the exposure unit 10, speeds of driving motors 60 (see FIG. 5A) for providing a rotation driving force to the photosensitive drum 21 do not have to be individually controlled. Accordingly, the number of driving motors 60 for the photosensitive drum 21, which are relatively expensive, may be reduced. For example, when the number of photosensitive drums 21 is 4, the number of driving motors 60 may be less than the number of photosensitive drums 21. For example, the number of driving motors 60 may be reduced to 2 as shown in FIG. 5A. However, the number of driving motors 60 does not have to be less than the number of photosensitive drums 21, and according to circumstances, the number of driving motors 60 may be the same as the number of photosensitive drums 21 as shown in FIG. 5B. In FIGS. 5A and 5B, reference numeral 22 denotes a gear connected to the photosensitive drum 21 with a same shaft, and reference numeral 61 denotes a connection gear for linking gears 22 to each other.

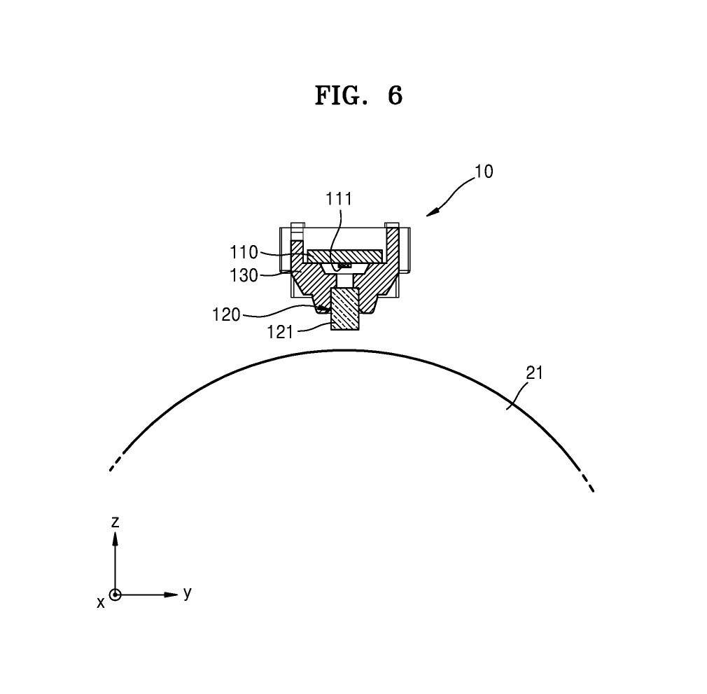

FIG. 6 illustrates the exposure unit 10 according to an exemplary embodiment. Referring to FIG. 6, the exposure unit 10 may include a substrate 110, a lens array 120, and a housing 130 supporting the substrate 110 and the lens array 120.

A plurality of light sources 111 may be arranged on the substrate 110. The plurality of light sources 111 may be classified into certain light source modules LM (see FIG. 15). Each light source module LM may include a certain number of light sources 111.

The substrate 110 may be a circuit substrate for controlling the plurality of light sources 111. The plurality of light sources 111 may be arranged along a main scanning direction (x direction). For example, the plurality of light sources 111 may be arranged in a zigzag manner along the main scanning direction (x direction).

The light source 111 may emit light by a light-emitting diode (LED) scheme. The light source 111 may include an LED chip. However, the light source 111 is not limited thereto and may be variously modified only if the modified light source emits light on a surface to be scanned through a lens 121.

The lens array 120 includes a plurality of lenses 121. The plurality of lenses 121 may be may be arranged along the main scanning direction (x direction). For example, the plurality of lenses 121 may be arranged in a zigzag manner or an alternate manner along the main scanning direction (x direction). The plurality of lenses 121 may form an image on the surface of the photosensitive drum 21 by concentrating light emitted from the plurality of light sources 111 on the surface of the photosensitive drum 21.

The lens 121 and the light source 111 may be spaced apart from each other. For example, the lens 121 and the light source 111 may be spaced apart from each other in an optical axis direction (z direction). The optical axis direction (z direction) may be perpendicular to the main scanning direction (x direction) and perpendicular to a sub-scanning direction (y direction).

The housing 130 may support the substrate 110 and the lens array 120 such that the plurality of lenses 121 and the plurality of light sources 111 maintain a predetermined distance d2 therebetween. A material of the housing 130 may be a plastic material.

As described above, since the exposure unit 10 has a structure of emitting light generated by the light source 111 onto the photosensitive drum 21 through the lens 121, an exposure timing of the exposure unit 10 may be easily controlled by adjusting a signal applied to the light source 111 or the light source module LM without a structural modification.

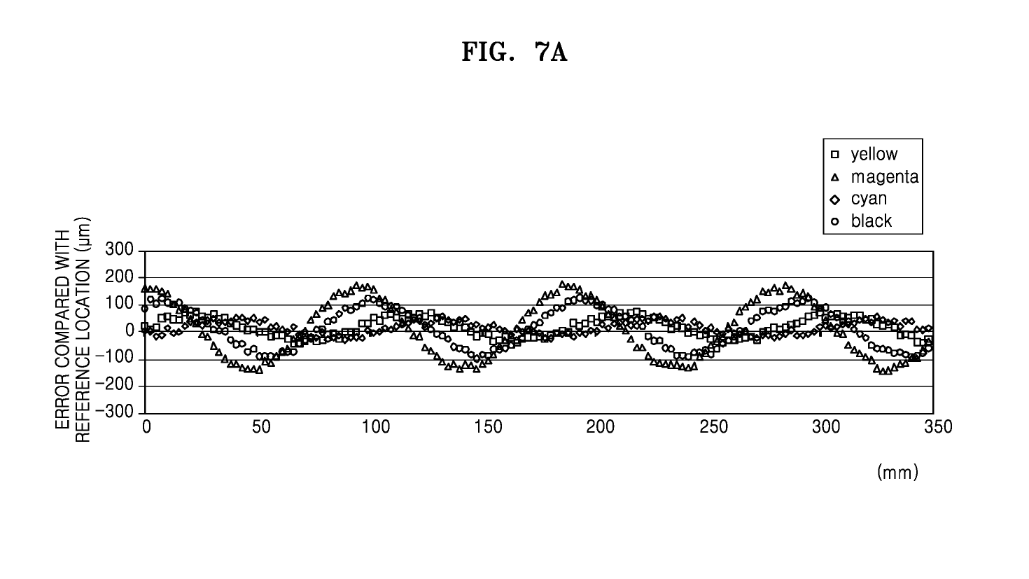

FIG. 7A illustrates a gap change in the detection patterns 310 according to a linear velocity change of the photosensitive drum 21 when an interval of an exposure timing is constant, according to a comparative example, and FIG. 7B illustrates a gap change in the detection patterns 310 according to a linear velocity change of the photosensitive drum 21 when an interval of an exposure timing is adjusted, according to an exemplary embodiment.

Referring to FIG. 7A, according to the comparative example, since an amplitude and a phase during a period of a linear velocity change of each of the plurality of photosensitive drums 21 vary, a change in a gap between the detection patterns 310 formed on the transfer belt 30 by each photosensitive drum 21 has a period of a sine function shape having a different amplitude and phase.

However, referring to FIG. 7B, according to the present exemplary embodiment, since the exposure controller 70 controls an exposure timing, even though an amplitude and a phase of a linear velocity change of each of the plurality of photosensitive drums 21 vary, a gap between the detection patterns 310 formed on the transfer belt 30 by each photosensitive drum 21 is constant. Accordingly, when the exposure controller 70 controls an exposure timing, an influence according to a linear velocity change of the photosensitive drum 21 may be offseted.

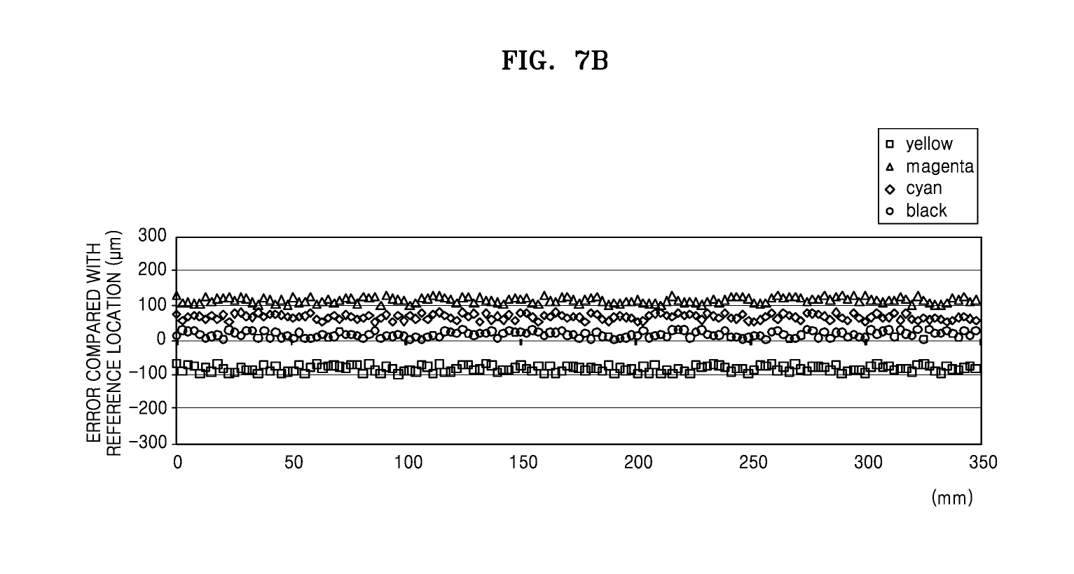

FIG. 8A illustrates an exposure control operation according to another exemplary embodiment, and FIG. 8B illustrates a result of the exposure control operation.

Referring to FIG. 8A, when the M-colored photosensitive drum 21 has a certain linear velocity change, a gap change between the detection patterns 310 formed on the transfer belt 30 according to the certain linear velocity change may have a sine curve shape as shown in a graph I.

A time interval may exist between a rotation start point of the photosensitive drum 21 and a start point of forming the detection patterns 310, and accordingly, a certain phase difference may occur between a period of a linear velocity change of the photosensitive drum 21 and a period of a gap change between the detection patterns 310 according to the linear velocity change of the photosensitive drum 21. Due to the phase difference, a gap between the detection patterns 310 may have an error (non-zero) when compared with a reference location. For example, a gap between the detection patterns 310 at a start point may have an error of about −150 μm when compared with the reference location.

To compensating for an offset of the gap between the detection patterns 310 at the start point, which has an error of about −150 μm when compared with the reference location, to be 0, it is most ideal that the exposure controller 70 controls a gap change between the detection patterns 310 to have an opposite phase. That is, it is most ideal that the exposure controller 70 controls the gap between the detection patterns 310 at the start point to have an error of about +150 μm when compared with the reference location as shown in a graph II.

However, when it is considered that a capacity of a memory to be secured increases as an interval of an exposure timing increases and an adjustable range of the exposure timing is limited, it may be difficult for the exposure controller 70 to control the exposure unit 10 such that a gap change between the detection patterns 310 is about +150 μm at the start point as shown in the graph II. For example, the gap change between the detection patterns 310 by the exposure controller 70 may be about 0 μm at the start point as shown in a graph III.

According to an exemplary embodiment, the exposure controller 70 may apply a signal for compensating for the phase Ph_color of the linear velocity change of the photosensitive drum 21 to the exposure unit 10.

For example, the exposure controller 70 may control the exposure timing of the exposure unit 10 such that the error compared with the reference location becomes 0 from the start point to a certain point as shown in a graph IV. The certain point may be a half of the product of the phase Ph_color and a diameter Do of the photosensitive drum 21 (Ph_color*Do/2).

In other words, when the exposure controller 70 compensates for a linear velocity change of the photosensitive drum 21 without taking into account a phase in the linear velocity change of the photosensitive drum 21, a gap between the detection patterns 310 may match the reference gap, but a start point of the detection patterns 310 may not match a reference start point due to a phase difference. Accordingly, in an image forming apparatus according to an exemplary embodiment, the exposure controller 70 may control the exposure unit 10 to start light exposure after the photosensitive drum 21 rotates by the phase Ph_color by taking into account the phase difference.

This exposure timing control may be applied to each of the plurality of exposure units 10. Accordingly, as shown in FIG. 8B, the detection patterns 310 corresponding to a plurality of colors may have an error of 0 compared with the reference location. For example, a gap between the detection patterns 310 for each color may have an error of 0 compared with the reference location after a certain time. Accordingly, offsets according to linear velocity changes of the plurality of photosensitive drums 21 may be removed. Herein, an offset according to a linear velocity change of the photosensitive drum 21 may be a difference from when a linear velocity of the photosensitive drum 21 is constant as the reference velocity.

However, the offsets according to the linear velocity changes of the plurality of photosensitive drums 21 do not have to be removed only if the offsets according to the linear velocity changes of the plurality of photosensitive drums 21 match each other.

For example, the exposure controller 70 may control the exposure unit 10 such that a gap change between the detection patterns 310 for one color is determined as a reference and gap changes between the detection patterns 310 for the other colors match the reference. In detail, when a gap change between the detection patterns 310 for a K color is determined as the reference, gap changes between the detection patterns 310 for the other colors, i.e., the Y, M, and C colors, may be controlled to match the gap change between the detection patterns 310 for the K color.

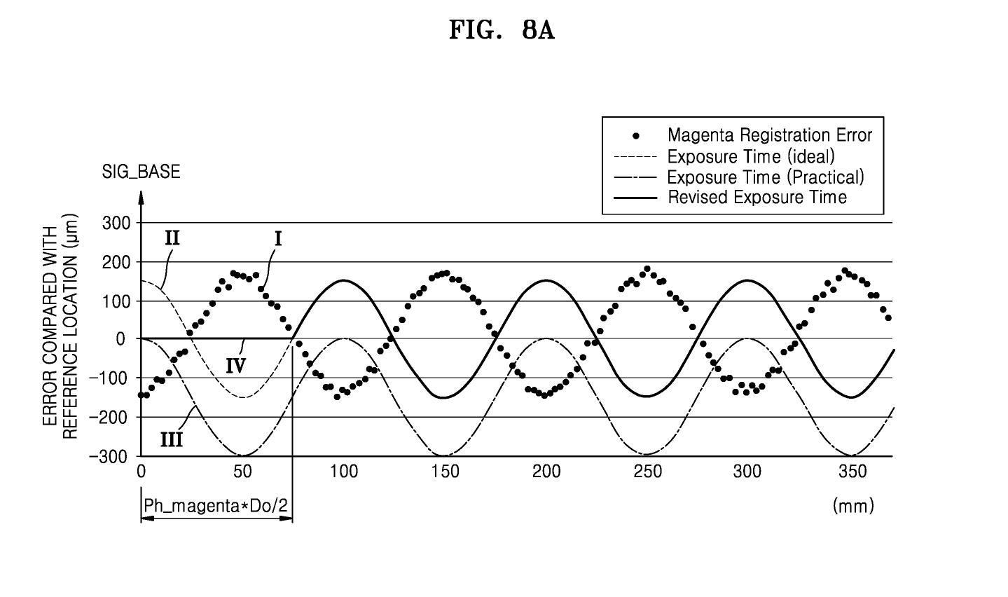

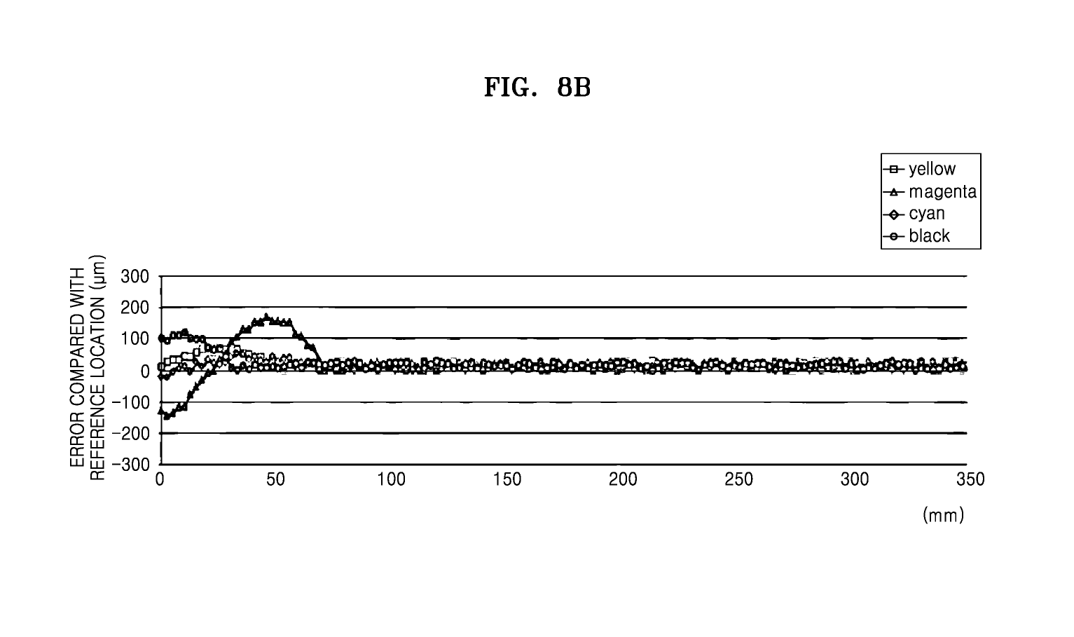

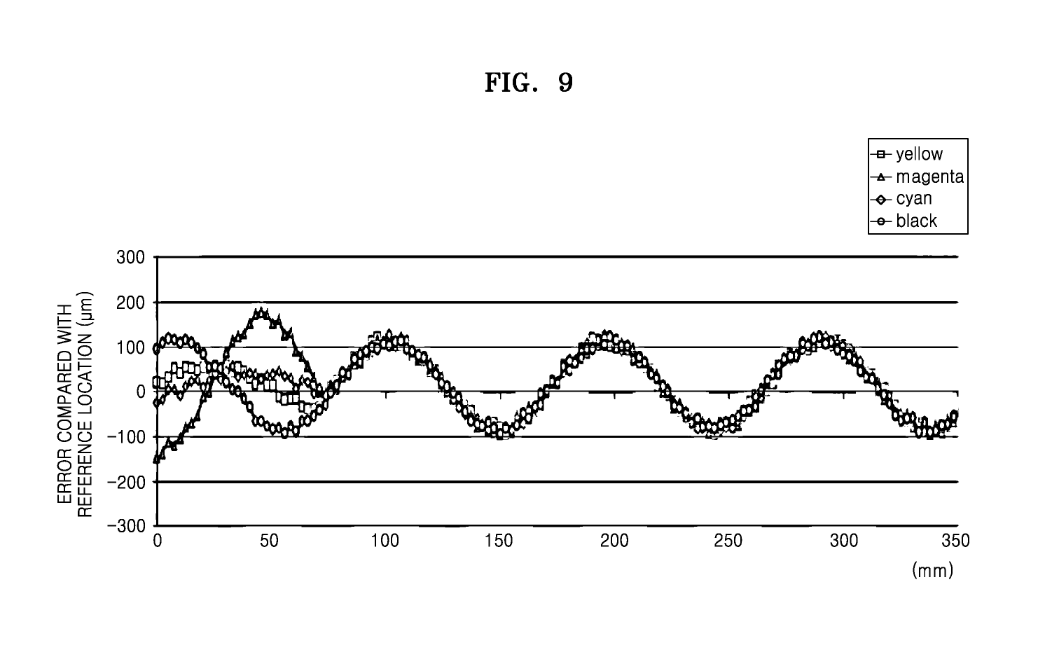

The reference may be determined as a value that is closest to an average amplitude value of a gap change between the detection patterns 310 by each photosensitive drum 21. For example, when an amplitude for the K color is 100 μm, an amplitude for the C color is 30 μm, an amplitude for the M color is 150 μm, and an amplitude for the Y color is 50 μm, the K color for which the amplitude is the closest to 83 μm that is the average amplitude may be determined as a reference color. Accordingly, as shown in FIG. 9, gap changes between the detection patterns 310 of the C, M, and Y colors may be aligned with a gap change between the detection patterns 310 of the K color.

Hereinafter, a method by which the detection unit 80 detects a linear velocity change of the photosensitive drum 21 is described.

For example, as shown in FIG. 3A, the detection unit 80 may detect a linear velocity change of the photosensitive drum 21 based on a gap between detection patterns 310 formed on the transfer belt 30.

In general color registration of an image, both periodic components of the plurality of photosensitive drums 21 and components of the driving rollers 31 and 32 for driving the transfer belt 30 may mainly appear. An influence according to the driving rollers 31 and 32 for driving the transfer belt 30 may be removed by adjusting a location of each photosensitive drum 21, but an influence according to each of the plurality of photosensitive drums 21 cannot be removed even though the location of each photosensitive drum 21 is adjusted since amplitudes and phases of the periodic components of the plurality of photosensitive drums 21 differ from each other and transfer locations on the transfer belt 30 differ from each other.

In addition, to remove a periodic component of a linear velocity of each photosensitive drum 21 from the color registration, a change in the periodic component of the linear velocity of each photosensitive drum 21 is supposed to be correctly detected. The change in the periodic component of each photosensitive drum 21 is determined by a magnitude A_color and a phase Ph_color of the periodic component of the photosensitive drum 21 for each color.

In detail, to remove a location mismatch amount due to the influence according to the driving rollers 31 and 32, in general, a pitch between the photosensitive drums 21 is matched with a period of the driving rollers 31 and 32. The pitch between the photosensitive drums 21 is related to a size of an image forming apparatus, and due to size limitation of the image forming apparatus, the driving rollers 31 and 32 of the transfer belt 30 are smaller than the photosensitive drums 21. In addition, to prevent the occurrence of slip when driving the transfer belt 30, it is recommended that a diameter of the driving rollers 31 and 32 is a certain value or more.

Because of these reasons described above, diameters of the photosensitive drums 21 and the driving rollers 31 and 32 are similar, and accordingly, periods affecting an image are similar. As a period difference decreases, distortion increases when a component is extracted through sampling from the image. When this distortion is avoided and only components of the photosensitive drums 21 are extracted and removed, a color location mismatch may be improved.

Therefore, in the current exemplary embodiment, when detection patterns 310 for color registration are formed, detection patterns 310 satisfying Equation 2 are formed.

S·(M−1)≧K˜λ (2)

In Equation 2, S denotes a center distance between detection patterns 310 for a same color, M denotes the number of detection patterns 310 for the same color, λ denotes a period of rotation of the photosensitive drum 21, and K denotes a minimum natural number that is greater than

$$\vert \frac{{D}_{i}}{{D}_{o} - {D}_{i}} \vert$$

where Dᵢ denotes a diameter of the driving rollers 31 and 32, and Dₒ denotes a diameter of the photosensitive drum 21.

That is, if detection patterns 310 are formed as many as a multiple of a circumferential length that is a minimum natural number greater than a value obtained by dividing the diameter of the driving rollers 31 and 32 by a value obtained by subtracting the diameter of the driving rollers 31 and 32 for driving the transfer belt 30 from the diameter of the photosensitive drum 21, a linear velocity component of the image forming medium (e.g., the transfer belt 30) may be removed when detecting a linear velocity of the photosensitive drum 21 to be described below.

Although it has been described in the present exemplary embodiment that K is calculated using the diameter of the driving rollers 31 and 32 for driving the transfer belt 30 and the diameter of the photosensitive drum 21, as described above, since the driving rollers 31 and 32 for driving the transfer belt 30 are typically smaller than the photosensitive drums 21, K may be a constant value of 4.

FIG. 10A illustrates detection patterns 311 and 312 according to a first exemplary embodiment. Referring to FIG. 10A, the detection patterns 311 and 312 transferred to the transfer belt 30 have a shape of a plurality of bars. The bar-shaped patterns 311 and 312 are designed to have a same thickness and a same gap Δ. Each bar-shaped detection pattern 311 may be formed at a rising edge or falling edge timing of a signal generated by a sensor.

In detail, when a gap between nth and (n+1)th detection patterns 311 of an ith color is Δ_in and a reference gap is Δ_i, Xn is Δ_in-Δ_i. In this case, a magnitude of a component of the photosensitive drum 21 is

$$\vert \frac{2 {\sum }_{n = 1}^{M - 1} {X}_{n} {e}^{- j 2 π \frac{kn}{N}}}{M - 1} \vert ,$$

and a phase thereof is

$$\frac{2 {\sum }_{n = 1}^{M - 1} {X}_{n} {e}^{- j 2 π \frac{kn}{N}}}{M - 1} .$$

These detection patterns 311 have a length corresponding to a preset integer multiple (e.g., 4) of a circumferential length of a corresponding photosensitive drum 21. This is to stably secure data, increase error fitting accuracy, and exclude an influence of a linear velocity change of the transfer belt 30. Then, detection patterns are repetitively outputted a times in the order of YMCK for the photosensitive drums 21.

For example, for the photosensitive drums 21, K, M, C, and Y patterns are respectively formed and transferred to the transfer belt 30.

The detection unit 80 detects a periodic linear velocity change of each photosensitive drum 21 and obtains a gap change function by fitting, as a sine function, a gap change according to the detected periodic linear velocity change, and the exposure controller 70 obtains a control function of each exposure unit 10 by using the gap change function, thereby significantly reducing a color mismatch due to a velocity change between photosensitive drums 21.

FIG. 10B illustrates detection patterns 311a and 312a according to a second exemplary embodiment.

Referring to FIG. 10B, to detect a gap change occurring due to a linear velocity change of the photosensitive drum 21, the detection patterns 311a and 312a transferred to the transfer belt 30 have a shape of a plurality of bars. The bar-shaped detection patterns 311a and 312a are obliquely arranged along a moving direction of the transfer belt 30. That is, the second exemplary embodiment differs from the first exemplary embodiment in that the bar-shaped detection patterns 311a and 312a are not perpendicularly but obliquely arranged along a moving direction of the transfer belt 30. Besides, a magnitude and a phase of a component of the photosensitive drum 21 according to the second exemplary embodiment are the same as those according to the first exemplary embodiment.

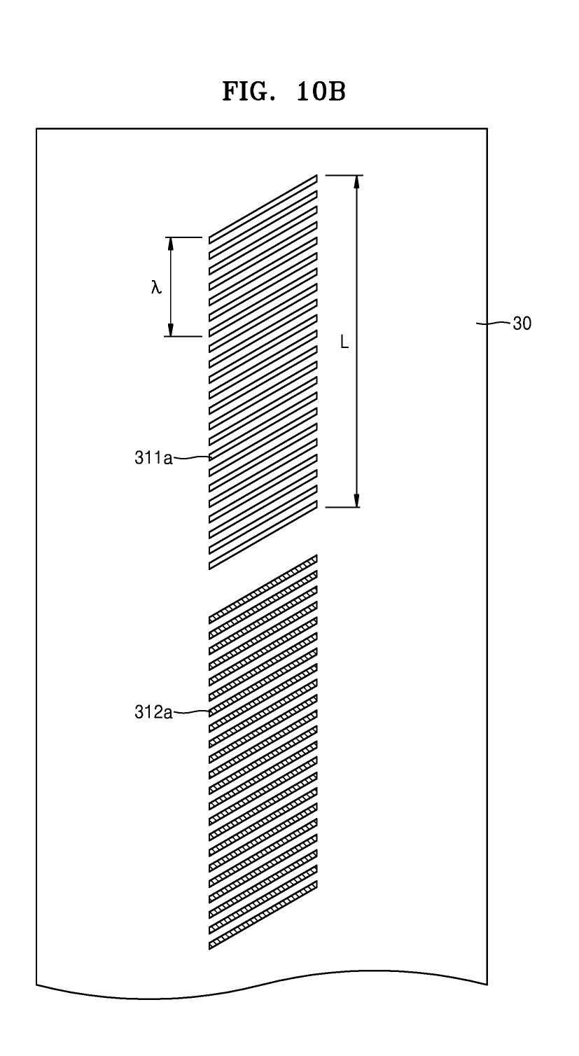

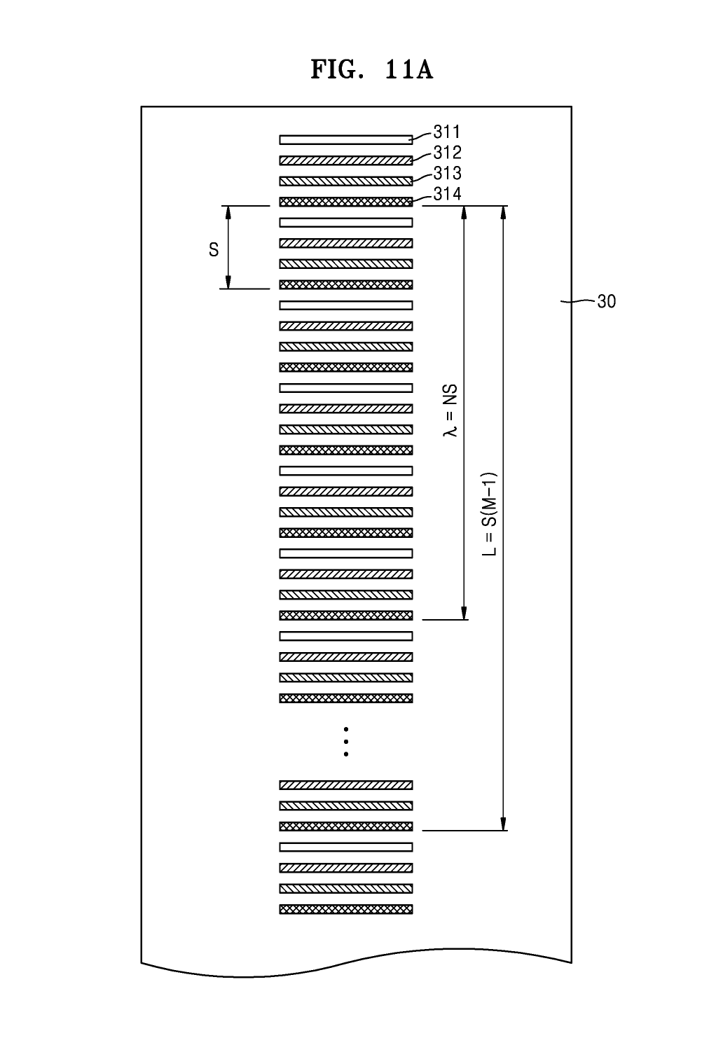

FIG. 11A illustrates detection patterns 311, 312, 313, and 314 according to a third exemplary embodiment.

Referring to FIG. 11A, the preset detection patterns 311, 312, 313, and 314 have a shape of a plurality of bars, and the bar-shaped detection patterns 311, 312, 313, and 314 for the respective photosensitive drums 21 are alternately arranged. That is, a method of reducing a length of total detection patterns 311, 312, 313, and 314 by forming neighboring detection patterns 311, 312, 313, and 314 with different colors may be used.

That is, to increase component extraction accuracy of the photosensitive drums 21, only if a total length S(M−1) of a single color satisfies 4A or more, a gap between the detection patterns 311, 312, 313, and 314 may be widened. In this case, the length of the total detection patterns 311, 312, 313, and 314 may be reduced by inserting a detection pattern 312 for a second color between neighboring detection patterns 311 for a same color. Magnitudes and phases of components of the photosensitive drums 21 may be obtained from signals read from the detection patterns 311, 312, 313, and 314 in the same manner as the first and second exemplary embodiments.

FIG. 11B illustrates detection patterns 311a, 312a, 313a, and 314a generated according to a fourth exemplary embodiment.

Referring to FIG. 11B, the preset detection patterns 311a, 312a, 313a, and 314a have a shape of a plurality of bars, and the bar-shaped detection patterns 311a, 312a, 313a, and 314a for the respective photosensitive drums 21 are alternately arranged. Also, the bar-shaped detection patterns 311a, 312a, 313a, and 314a are obliquely arranged along a moving direction of the transfer belt 30. That is, a method of reducing a length of total detection patterns 311a, 312a, 313a, and 314a by forming neighboring detection patterns 311a, 312a, 313a, and 314a with different colors may be used.

That is, to increase component extraction accuracy of the photosensitive drums 21, only if a total length S(M−1) of a single color satisfies 4A or more, a gap between the detection patterns 311a, 312a, 313a, and 314a may be widened. In this case, the length of the total detection patterns 311a, 312a, 313a, and 314a may be reduced by inserting a detection pattern 312a for a second color between neighboring detection patterns 311a for a same color. Magnitudes and phases of components of the photosensitive drums 21 may be obtained from signals read from the detection patterns 311a, 312a, 313a, and 314a in the same manner as the first through third exemplary embodiments.

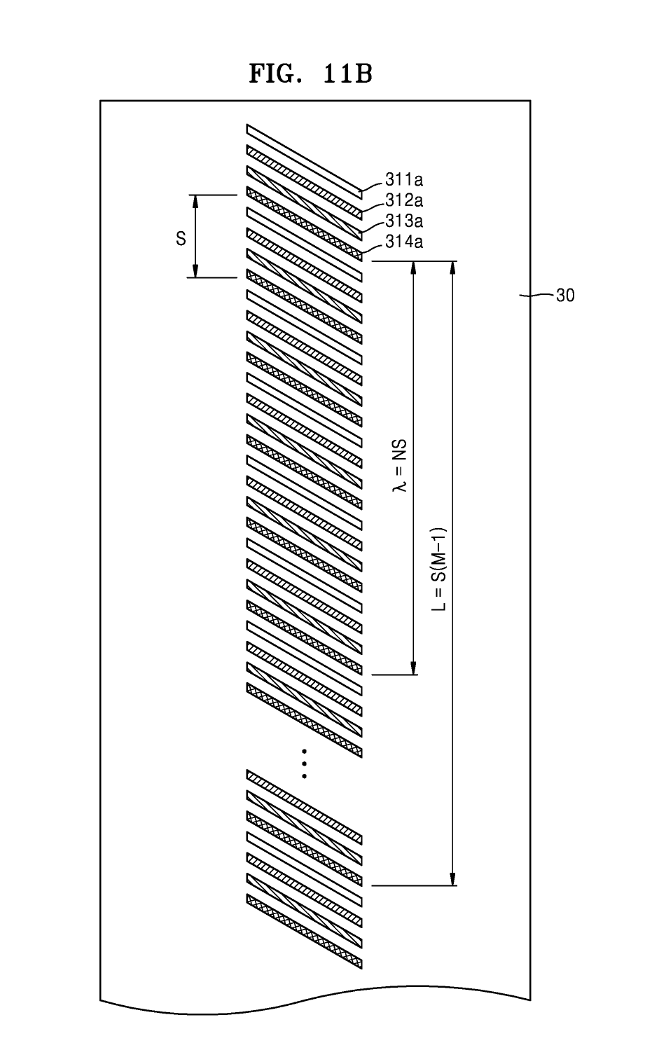

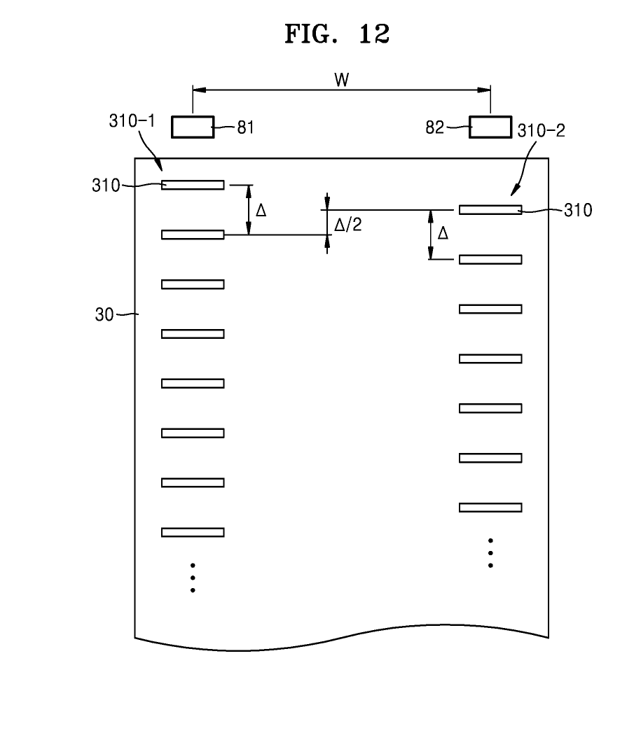

FIG. 12 illustrates detection patterns 310 generated according to a fifth exemplary embodiment and the detection unit 80 for detecting the detection patterns 310. Referring to FIG. 12, the detection patterns 310 may be arranged in parallel on the transfer belt 30 so as to be spaced in the main scanning direction. For example, a first detection pattern arrangement 310-1 is formed on the left side of the transfer belt 30, and a second detection pattern arrangement 310-2 is formed on the right side of the transfer belt 30. The detection unit 80 may include first and second sensors 81 and 82 spaced apart from each other in the main scanning direction. A distance between the first and second sensors 81 and 82 may be W.

Each detection pattern 310 of the first detection pattern arrangement 310-1 may be arranged alternately with each detection pattern 310 of the second detection pattern arrangement 310-2 in the sub-scanning direction. For example, when a gap between the detection patterns 310 of the first detection pattern arrangement 310-1 in the sub-scanning direction is Δ, and a gap between the detection patterns 310 of the second detection pattern arrangement 310-2 in the sub-scanning direction is Δ, a gap between each detection pattern 310 of the first detection pattern arrangement 310-1 and each detection pattern 310 of the second detection pattern arrangement 310-2 in the sub-scanning direction may be Δ/2.

As described above, by arranging a plurality of detection patterns 310 to be spaced in the main scanning direction and alternated in the sub-scanning direction, a resolution of the detection unit 80 may increase without increasing a total length of the detection patterns 310.

A skew of an image forming apparatus may be detected by the detection patterns 310 arranged to be spaced in the main scanning direction and the first and second sensors 81 and 82 for detecting the detection patterns 310.

For example, the first and second sensors 81 and 82 detect detection patterns 310 of the first and second detection pattern arrangements 310-1 and 310-2, respectively. In other words, the first sensor 81 detects a detection pattern 310 of the first detection pattern arrangement 310-1, and the second sensor 82 detects a detection pattern 310 of the second detection pattern arrangement 310-2. A skew of an image forming apparatus may be detected based on an interval between a time point where the first sensor 81 detects the detection pattern 310 and a time point where the second sensor 82 detects the detection pattern 310.

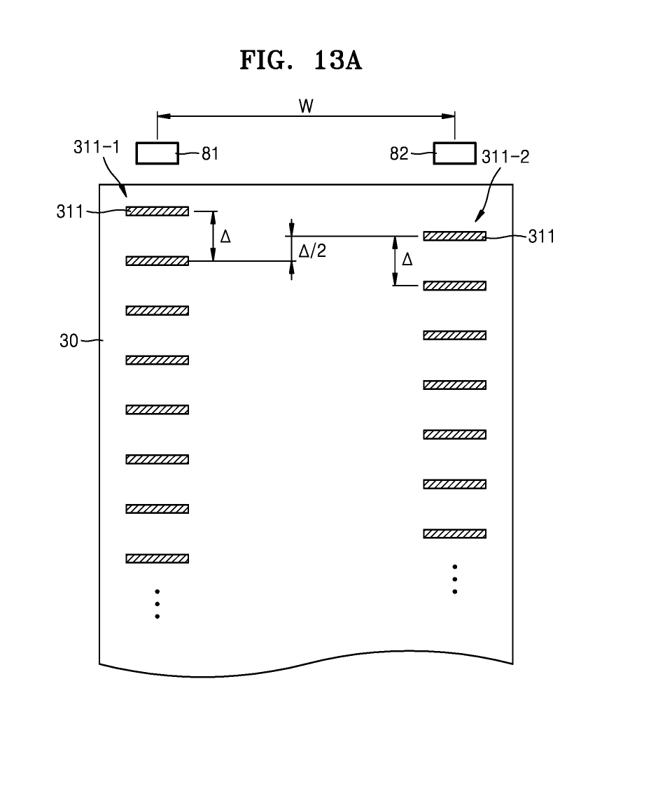

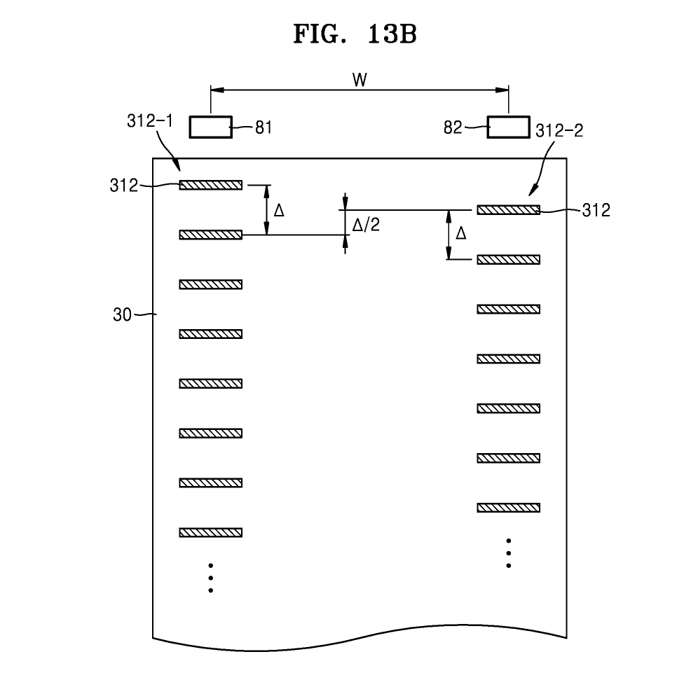

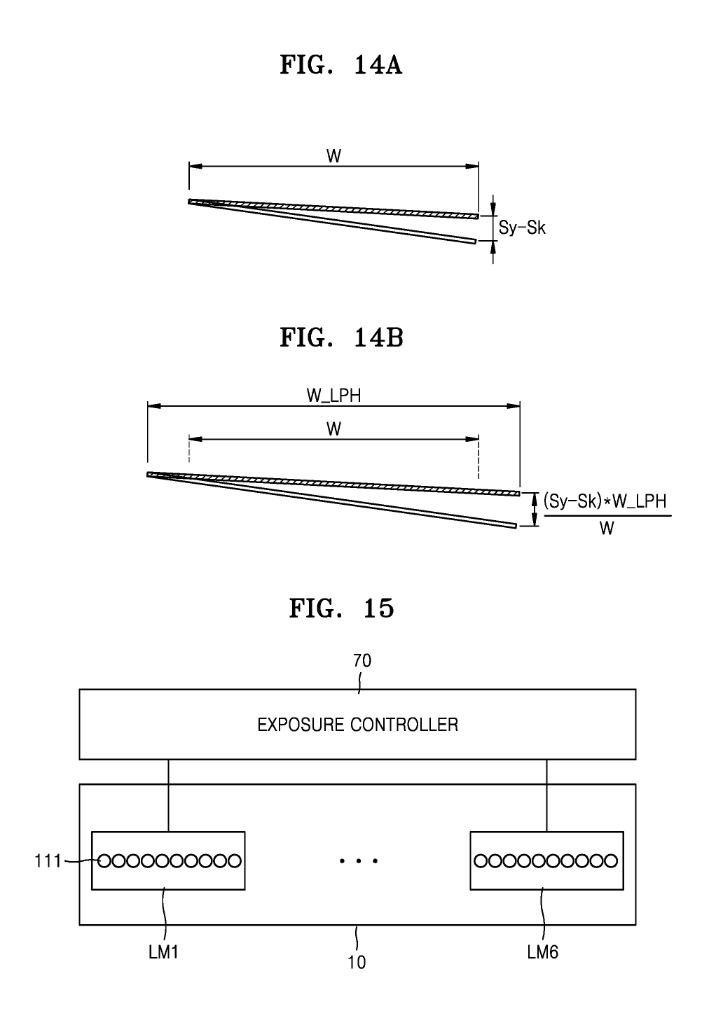

FIGS. 13A and 13B illustrate an operation of detecting detection patterns 311 by the first and second sensors 81 and 82, and FIGS. 14A and 14B illustrate an operation of detecting a skew of an image forming apparatus based on the detection result of the first and second sensors 81 and 82.

Referring to FIGS. 13A and 13B, the first and second sensors 81 and 82 are arranged to be spaced apart in the main scanning direction and detect the detection patterns 311 moving in the sub-scanning direction by the transfer belt 30. The distance between the first and second sensors 81 and 82 in the main scanning direction may be W.

Referring to FIG. 13A, the first sensor 81 detects a detection pattern 311 of a first detection pattern arrangement 311-1 for a K color, and the second sensor 82 detects a detection pattern 311 of a second detection pattern arrangement 311-2 for the K color. It may be detected that the K color of the image forming apparatus is skewed by Sk in the sub-scanning direction based on an interval between a time point where the first sensor 81 detects the detection pattern 311 for the K color and a time point where the second sensor 82 detects the detection pattern 311 for the K color.

Referring to FIG. 13B, the first sensor 81 detects a detection pattern 312 of a first detection pattern arrangement 312-1 for a Y color, and the second sensor 82 detects a detection pattern 312 of a second detection pattern arrangement 311-2 for the Y color. It may be detected that the Y color of the image forming apparatus is skewed by Sy in the sub-scanning direction based on an interval between a time point where the first sensor 81 detects the detection pattern 312 for the Y color and a time point where the second sensor 82 detects the detection pattern 312 for the Y color.

Accordingly, referring to FIG. 14A, a partial image of the Y color of the image forming apparatus is skewed by Sy-Sk in the sub-scanning direction with respect to a partial image of the K color.

However, referring to FIG. 14B, a length W_LPH of the exposure unit 10 may be greater than the distance W between the first and second sensors 81 and 82. Accordingly, the skew of the image forming apparatus may be greater than the skew Sy-Sk detected by the first and second sensors 81 and 82. For example, a skew of a Y-colored image with respect to a K-colored image in the image forming apparatus may be (Sy−Sk)*W_LPH/W.

FIG. 15 illustrates the exposure unit 10 according to an exemplary embodiment. In FIG. 15, one of the plurality of exposure units 10K, 10Y, 10M, and 10C is described for convenience of description, and a substrate, a lens array, and a housing except for the light source modules LM in the exposure unit 10 are not shown.

Referring to FIG. 15, the exposure unit 10 may include a plurality of (first to sixth) light source modules LM1 to LM6. Each of the first to sixth light source modules LM1 to LM6 includes a plurality of light sources 111 arranged along the main scanning direction. The light source 111 may be an LED chip.

The exposure controller 70 is individually connected to the first to sixth light source modules LM1 to LM6. The exposure controller 70 individually controls the first to sixth light source modules LM1 to LM6.

The exposure controller 70 compensates for a skew between color images of an image forming apparatus by individually controlling the first to sixth light source modules LM1 to LM6 of the exposure unit 10. In other words, the exposure controller 70 may control operating timings of the first to sixth light source modules LM1 to LM6 by adjusting a timing of applying a start signal to each of the first to sixth light source modules LM1 to LM6.

The exposure controller 70 operates by receiving print data. The exposure controller 70 receives print data from a main board or a central processing unit (CPU) included in the image forming apparatus and controls turn-on of the first to sixth light source modules LM1 to LM6 according to the print data. The print data indicates an image to be formed. The exposure controller 70 controls operating timings of the first to sixth light source modules LM1 to LM6 by taking into account a skew between colors when controlling turn-on of the first to sixth light source modules LM1 to LM6 according to the print data.

The exposure controller 70 further includes a memory in which information about operating timings of the first to sixth light source modules LM1 to LM6 is stored. In other words, the exposure controller 70 previously stores, in the memory, information about operating timings of the first to sixth light source modules LM1 to LM6, which correspond to a skew between colors.

The exposure controller 70 controls operating timings of the first to sixth light source modules LM1 to LM6 by individually applying start signals to the first to sixth light source modules LM1 to LM6. The exposure controller 70 adjusts timings of applying the start signals to the first to sixth light source modules LM1 to LM6 according to a skew between color images in the sub-scanning direction. In other words, the exposure controller 70 corrects an image by adjusting timings of the start signals to be inputted to the first to sixth light source modules LM1 to LM6 to adjust an exposure timing.

The first to sixth light source modules LM1 to LM6 operate by receiving a signal from the exposure controller 70. The first to sixth light source modules LM1 to LM6 operate according to the start signals individually received from the exposure controller 70 and emit light according to a data signal (or a turn-on signal). The first to sixth light source modules LM1 to LM6 may be arranged in a zigzag manner in two lines.

Hereinafter, an operation of compensating for a skew of a Y-colored image through exposure timing control of the exposure controller 70 is described.

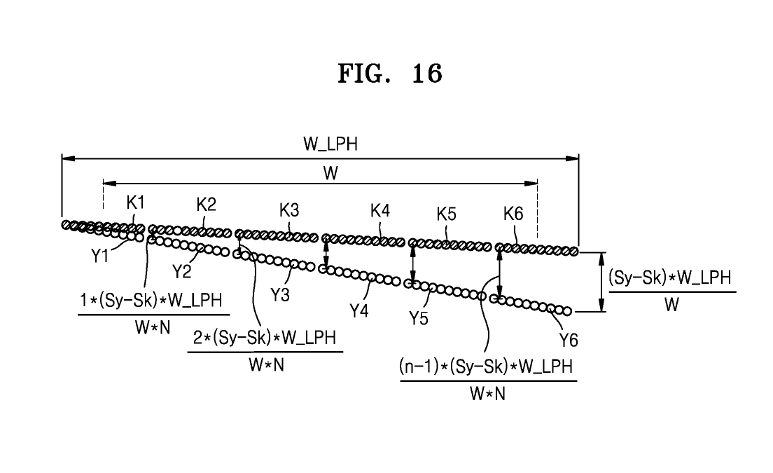

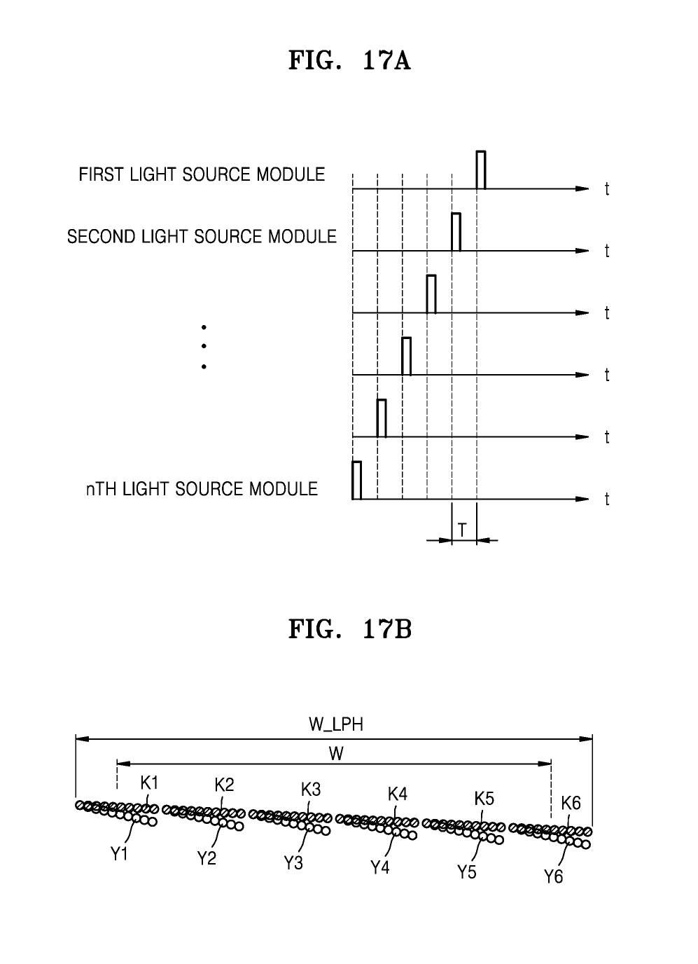

FIG. 16 illustrates a skew of Y-colored images Y1 to Y6 with respect to K-colored images K1 to K6 before the exposure controller 70 controls an exposure timing. FIG. 17A illustrates a timing diagram of applying exposure signals by the exposure controller 70, according to an exemplary embodiment, and FIG. 17B illustrates a skew compensation of the Y-colored images Y1 to Y6 with respect to the K-colored images K1 to K6 after the exposure controller 70 controls an exposure timing, according to an exemplary embodiment. Although it is shown in FIGS. 16 and 17B for convenience of description that neighboring toner images K1 to K6 and Y1 to Y6, e.g., the toner images K1 and K2, are formed to be spaced apart from each other in the main scanning direction, at least a portion of the toner images K1 to K6 and Y1 to Y6 may be practically superimposed in the main scanning direction.

Referring to FIG. 16, a skew amount of the Y-colored images Y1 to Y6 with respect to the K-colored images K1 to K6, which is detected by the detection unit 80 including the first and second sensors 81 and 82, may be (Sy−Sk)*W_LPH/W. When the exposure units 10Y and 10K for the Y and K colors include N light source modules (N is an integer that is 2 or more), a skew amount of a Y-colored image with respect to a K-colored image by an nth light source module is (n−1)·(Sy−Sk)·W_LPH/(W·N). For example, a skew amount of the Y-colored image Y2 with respect to the K-colored image K2 by the second light source module LM2 is 1·(Sy−Sk)·W_LPH/(W·N), and a skew amount of the Y-colored image Y3 with respect to the K-colored image K3 by the third light source module LM3 is 2·(Sy−Sk)·W_LPH/(W·N). A skew amount of an image by an adjacent light source module for a same color is (Sy−Sk)·W_LPH/(W·N).

By taking into account the above description, the exposure controller 70 according to an exemplary embodiment may control an exposure timing of an nth light source module to be earlier by a time T corresponding to (Sy−Sk)·W_LPH/(W·N) than an exposure timing of an (n−1)th light source module. When the exposure controller 70 applies an exposure signal to the nth light source module, the exposure controller 70 applies the exposure signal by compensating for a time (n−1)·T. When a linear velocity of the photosensitive drum 21 is fo·Do·π, the time T is (Sy−Sk)·W_LPH/(W·N·fo·Do·π) where fo denotes revolutions per second of the photosensitive drum 21, and Do denotes a diameter of the photosensitive drum 21.

Referring to FIG. 17A, an exposure start time point of the second light source module LM2 may be earlier by T than an exposure start time point of the first light source module LM1. An exposure start time point of the third light source module LM3 may be earlier by T than an exposure start time point of the second light source module LM2. As such, an exposure start time point of an nth light source module may be earlier by T than an exposure start time point of an (n−1) light source module. That is, the exposure start time point of the nth light source module may be earlier by (n−1)·T than the exposure start time point of the first light source module LM1.

Accordingly, as shown in FIG. 17B, a skew amount of a Y-colored image with respect to a K-colored image by the nth light source module may be reduced or removed. For example, the exposure controller 70 may make an exposure timing of the second light source module LM2 earlier by T to match one end portion of the Y-colored image Y2 by the second light source module LM2 with one end portion of the K-colored image Y2. Also, the exposure controller 70 may make an exposure timing of the third light source module LM3 earlier by 2 T to match one end portion of the Y-colored image Y3 by the third light source module LM3 with one end portion of the K-colored image Y3.

Since the exposure controller 70 is individually connected to the first to sixth light source modules LM1 to LM6, the exposure controller 70 may individually determine a timing of applying an exposure signal to each of the first to sixth light source modules LM1 to LM6. Therefore, the exposure controller 70 may determine a compensation time for each of the first to sixth light source modules LM1 to LM6 and adjust a timing of applying an exposure signal according to the determined compensation time.

A method of using detection patterns 310 formed on the transfer belt 30 to detect a linear velocity change of the photosensitive drum 21 has been mainly described in the above-described embodiments. However, to detect the linear velocity change of the photosensitive drum 21, the detection patterns 310 do not have to be formed on the transfer belt 30, and various modifications may be used instead.

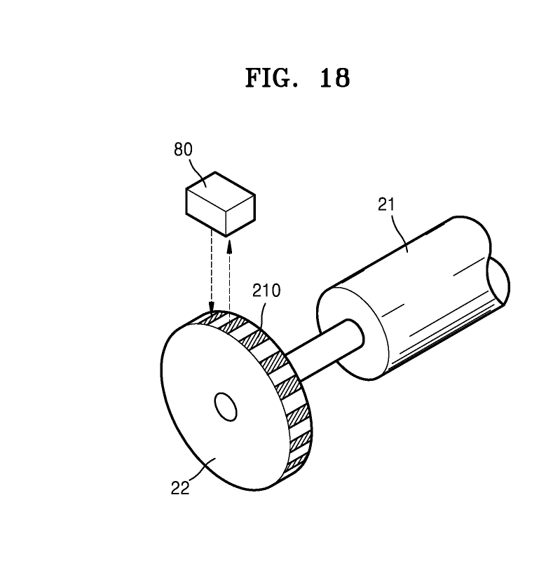

For example, as shown in FIG. 18, the linear velocity change of the photosensitive drum 21 may be directly detected by forming certain detection patterns 210 on the gear 22 connected to the photosensitive drum 21 and detecting the detection patterns 210 by the detection unit 80.

According to an image forming apparatus and a method of controlling an exposure unit according to an exemplary embodiment, an influence according to a linear velocity change of a photosensitive drum may be reduced or removed by controlling an exposure timing of the exposure unit according to the linear velocity change of the photosensitive drum.

According to the image forming apparatus according to another exemplary embodiment, a skew of a toner image may be compensated for by individually controlling light source modules of the exposure unit.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. An image forming apparatus, comprising:
at least one rotatable photosensitive drum;
at least one exposure unit configured to form an electrostatic latent image on a surface of the at least one rotatable photosensitive drum, the at least one exposure unit including a plurality of light sources arranged along a main scanning direction;
a developing unit configured to form a toner image by developing the electrostatic latent image formed on the surface of the at least one rotatable photosensitive drum;
a transfer medium to which the toner image formed on the surface of the at least one rotatable photosensitive drum is transferred;
a detection unit configured to detect a change in a linear velocity of the at least one rotatable photosensitive drum, which occurs while the at least one rotatable photosensitive drum rotates; and
an exposure controller configured to control an exposure timing of the at least one exposure unit based on the change of the linear velocity of the at least one rotatable photosensitive drum, which is detected by the detection unit.

2. The image forming apparatus of claim 1, wherein the exposure controller is further configured to control an interval of the exposure timing of the exposure unit to be shorter than a reference interval when the linear velocity of the at least one photosensitive drum is faster than a reference velocity and to control the interval of the exposure timing of the at least one exposure unit to be longer than the reference interval when the linear velocity of the photosensitive drum is slower than the reference velocity.

3. The image forming apparatus of claim 2, wherein the exposure controller is further configured to control the exposure timing of the at least one exposure unit by taking into account a phase of the change of the linear velocity of the at least one photosensitive drum.

4. The image forming apparatus of claim 1, comprising:
a plurality of photosensitive drums including the at least one photosensitive drum, the plurality of photosensitive drums being associated with different colors, and
a plurality of exposure units including the at least one exposure unit, the plurality of exposure units corresponding to the plurality of photosensitive drums.

5. The image forming apparatus of claim 4, wherein the detection unit is further configured to detect a change in linear velocity corresponding to the plurality of photosensitive drums, and
the exposure controller is further configured to control an exposure timing of corresponding to the plurality of exposure units based on the change in the linear velocity corresponding to the plurality of photosensitive drums.

6. The image forming apparatus of claim 4, wherein the exposure controller is further configured to control the exposure timing of the exposure unit such that offsets according to the change of the linear velocity corresponding to the plurality of photosensitive drums are removed or match each other.

7. The image forming apparatus of claim 1, wherein a plurality of detection patterns arranged along a sub-scanning direction are formed on the transfer medium, and
the detection unit is further configured to detect the change in the linear velocity of the at least one photosensitive drum from a gap change in the plurality of detection patterns in the sub-scanning direction.

8. The image forming apparatus of claim 7, wherein the plurality of detection patterns are parallel to or inclined from the main scanning direction.

9. The image forming apparatus of claim 7, wherein the plurality of detection patterns comprise a first detection pattern and a second detection pattern spaced apart from each other along the main scanning direction, and
the detection unit comprises a first sensor and a second sensor configured to detect the first detection pattern and the second detection pattern.

10. The image forming apparatus of claim 9, wherein the first detection pattern is arranged alternately with the second detection pattern in the sub-scanning direction.

11. The image forming apparatus of claim 9, wherein the exposure unit comprises a plurality of light source modules including light sources, and
the exposure controller is further configured to individually control exposure timings of the plurality of light source modules.

12. The image forming apparatus of claim 4, further comprising:
at least one driving motor configured to provide a rotation driving force to the plurality of photosensitive drums,
wherein a number of driving motors is less than a number of photosensitive drums.

13. An image forming apparatus, comprising:
at least one rotatable photosensitive drum;
at least one exposure unit configured to form an electrostatic latent image on a surface of the at least one photosensitive drum, the at least one exposure unit including a plurality of light source modules having a plurality of light sources and arranged along a main scanning direction;
at least one developing unit configured to form a toner image by developing the electrostatic latent image formed on the surface of the at least one photosensitive drum;
a transfer medium to which the toner image formed on the surface of the at least one photosensitive drum is transferred;
a detection unit configured to detect a skew of the toner image transferred to the transfer medium by detecting a shift of a detection patterns in a sub-scanning direction, the detection patterns being arranged on the transfer medium so as to be spaced apart from each other in the sub-scanning direction and the main scanning direction; and
an exposure controller configured to individually control exposure timings of the plurality of light source modules based on the skew detected by the detection unit.

14. A method of controlling an exposure unit, the method comprising:
detecting a change in a linear velocity of at least one photosensitive drum while the at least one photosensitive drum rotates; and
controlling a timing of exposure which forms an electrostatic latent image on a surface of the at least one photosensitive drum based on the detected change in the linear velocity of the at least one photosensitive drum.

15. The method of claim 14, wherein when the linear velocity of the at least one photosensitive drum is faster than a reference velocity, an interval of the timing of the exposure is controlled to be shorter than a reference interval, and
when the linear velocity of the at least one photosensitive drum is slower than the reference velocity, the interval of the timing of the exposure is controlled to be longer than the reference interval.

16. The method of claim 15, wherein the timing of the exposure is controlled by taking into account a phase of the change in the linear velocity of the at least one photosensitive drum.

17. The method of claim 14, wherein a plurality of photosensitive drums including the at least one photosensitive drum are provided,
the detecting comprises detecting changes in a linear velocity corresponding to the plurality of photosensitive drums, and
the controlling comprises controlling the timing of the exposure such that offsets according to the changes in the linear velocity corresponding to the plurality of photosensitive drums are removed or match each other.

18. The method of claim 14, wherein a skew amount of a toner image is detected by using a first detection pattern and a second detection pattern spaced apart from each other along a main scanning direction and a first sensor and a second sensor configured to detect a change in the first detection pattern and the second detection pattern.

19. The method of claim 18, wherein exposure timings of a plurality of light source modules are individually controlled based on the skew amount of the toner image.

20. The image forming apparatus of claim 1, wherein the exposure timing is adjusted to compensate for the change of the linear velocity of the at least one rotatable photosensitive drum.
